(19) United States
(12) Patent Application Publication
(10) Pub. No.: US 2005/0176331 A1
(43) Pub. Date: Aug. 11, 2005

(54) Breathable articles

(76) Inventors: Jill M Martin, Pearland, TX (US); Pak-Meng Cham, Lake Jackson, TX (US)

Correspondence Address: WHYTE HIRSCHBOECK DUDEK S.C., 555 EAST WELLS STREET, SUITE 1900, MILWAUKEE, WI, 53202, US

(21) Appl. No.: 10/513,738

(22) PCT Filed: May 5, 2003
(86) PCT No.: PCT/US03/14016

Related U.S. Application Data
(60) Provisional application No. 60/379,677, filed on May 9, 2002.

(51) Int. Cl. B32B 27/12

(52) U.S. Cl. 442/396; 442/327

(57) ABSTRACT

Layered, water vapor permeable composite comprise at least one water vapor permeable film layer and at least one substrate layer, the water vapor permeable film (i) comprising at least one film forming polymer and at least one inert porous filler, (ii) having a water vapor transmission rate of at least 1000 g/m²/day, and (iii) activated. Representative film forming polymers include ethylene interpolymers, and representative fillers include silica glass beads. One exemplary method of activating the film is to subject it to sufficient pressure such that the glass beads are crushed within the film matrix.

### CROSS REFERENCE TO RELATED APPLICATION

This application claims the benefit under 35 USC §119(e) of U.S. Provisional Application No. 60/379,677 filed May 9, 2002.

### FIELD OF THE INVENTION

The present invention relates to a composite comprising a water vapor permeable film and one or more substrates, such as a non-woven fabric. In one aspect, the present invention relates to a composite comprising a water vapor permeable film containing an inert, porous filler while in another aspect, the invention relates to a composite in which the water vapor permeable film is elastic. The present invention has particular applicability in industrial and consumer articles in which the composite must have both a high water vapor transmission rate and liquid impermeability.

### BACKGROUND OF THE INVENTION

Water vapor permeable and water impermeable films are known in the art. Such breathable films have been suggested for use in various consumer and industrial articles, including, for example, disposable diapers, limited use apparel and house wrap.

One way to make plastic films breathable is the use of fillers, for example calcium carbonate. Breathability is attained by uniaxially or biaxially stretching the filler-containing plastic films, thus forming voids in the areas around the filler particles which allow for the passage of water vapor molecules through the film. Filler loadings in such films are typically high, that is at least about 20 percent by weight or more. For example, U.S. Pat. No. 4,777,073 discloses breathable films comprising LLDPE and 34 to 62 percent by weight (corresponding to 15 to 35 percent by volume) of a filler. International patent application WO 98/05502 teaches that breathable films with good water vapor transmission rates cannot be achieved with filler amounts of below 20 percent by weight of the polyolefin/filler composition.

Composites comprising such filler-based breathable films in combination with other materials are also known in the art. International patent application WO 99/14044 discloses a soft, breathable, elastic laminate of an elastic, filler-loaded film which has been stretched in at least two directions. U.S. Pat. No. 5,695,868 discloses a film/non-woven composite made from a breathable film bonded to a fibrous polyolefin non-woven web. The film, which contains from about 30 to about 80 weight percent of filler, is stretched to at least 2.5 times of its original length to thin the film and make it porous.

State of the art technology to make breathable films and composites has some disadvantages and limitations. For example, films with high filler loadings are rather difficult to process. A film-stretching step may lead to significant scrap rates. Using current technology, reaching and maintaining a high rate of prime production can be problematic.

Films comprising filler may also be useful in packaging applications. International patent applications WO 92/02580, WO 95/07949 and WO 99/33658 all disclose packaging films comprising a film-forming polymer and a filler having a particle size which is greater than the intrinsic film thickness. Owing to their decreased carbon dioxide to oxygen permeability ratio the films can provide produce-specific conditions in controlled atmosphere packaging.

There still is the need for breathable films and composites suitable for use in nonpackaging applications. These applications require a film that provides a high water vapor transmission rate in combination with advantageous physical properties. Such films and composites should also be producible in a cost efficient manner.

### SUMMARY OF THE INVENTION

In one embodiment of the invention, a layered, water vapor permeable composite comprises at least one water vapor permeable film layer and at least one substrate layer, the water vapor permeable film (i) comprising at least one film forming polymer and at least one inert porous filler, (ii) having a water vapor transmission rate of at least 1000 g/m²/day, and (iii) activated. The substrate layer can be either woven or nonwoven, the film-forming polymer can be an elastomer, and the filler can be either naturally porous or nonporous. The film can be activated in any suitable manner, but is typically activated by subjecting the filler-containing film to sufficient pressure to crush the filler particles.

In another embodiment of the invention, the composite is an article of manufacture. The article can take any one of a number of different forms including, but not limited to, an absorbent hygiene product, a medical disposable product, a surgical disposable product, protective apparel product, a geotextile product or a building material product.

In yet another aspect of the invention, the water vapor permeable composite is made by a method comprising the steps of (i) subjecting a film comprising at least one film-forming polymer and an inert filler material to pressure treatment, and (ii) joining the film to a substrate layer. In a preferred embodiment, steps (i) and (ii) are performed simultaneously.

### DETAILED DESCRIPTION OF THE INVENTION

The following terms have the specified meanings. The singular generally includes the plural, and the plural generally includes the singular unless indicated otherwise.

“Comprising” means “including, but not limited to”.

“Polymer” includes all possible geometrical configurations of the material, including isotactic, syndiotactic and random symmetries.

“Polymer blend”, “blend” and similar terms means mixtures of two or more polymers obtained either by post-reactor mixing of the polymers or reactor or in situ mixing of the polymers.

“Copolymer” means a polymer consisting of units derived from two different monomers.

“Interpolymer” means a polymer comprising units derived from at least two different monomers. An interpolymer includes, for example, copolymers, terpolymers and the like.

“Film” means a flat article, and includes sheets, strips, tapes and ribbons.

“Inert” means, as used in the term “inert, porous filler material” that the material is essentially chemically nonreactive with the film or the film-forming polymer under the conditions in which the film is made or used.

“Porous” “is used to describe an object, e.g., a filler particle, that is with natural pores, interstices, channels or similar passageways that extend from one surface of the object to another surface of the object or, in the case of a spherical or other one-surface object, from one point on the surface of the object to another point on the surface of the object. The passageways of a porous object are large enough to allow the passage through the object of significant amounts of small molecules of a gas or liquid, e.g., oxygen, nitrogen, water, benzene, etc.

“Nonporous” is used to describe an object, e.g., a filler particle, that is without natural pores, interstices, channels or similar passageways that extend from one surface of the object to another surface of the object or, in the case of a spherical or other one-surface object, from one point on the surface of the object to another point on the surface of the object. Significant amounts of small molecules of a gas or liquid, e.g., oxygen, nitrogen, water, benzene, etc., cannot pass through the object. Nonporous objects include porous objects with blocked or otherwise obstructed passageways, e.g., hydrated minerals.

“Crush”, “crushed”, “crushing” and similar terms are used to describe an object, e.g., a porous or nonporous filler particle, that has pores, interstices, channels or similar passageways that extend from one surface of the object to another surface of the object such that a gas or liquid can pass through the object; at least a portion of the pores, interstices, etc. in the object the result of activating the object, e.g., subjecting the object to a compressive force of sufficient magnitude so as to create one or more such passageways within the object.

“Activation”, “activating” and similar terms mean the creation of passageways within an object, porous or nonporous, e.g., a filler particle, by any means, but typically by subjecting the object to a compressive force. If the object is porous, then activation is the act of creating additional passageways from one surface of the object to another surface of the object.

“Intrinsic thickness” means the calculated thickness or gauge of a monolayer film, or a layer of a multilayer film. The intrinsic film thickness is the thickness of the film without a filler. Intrinsic thickness is the weight of the film in grams divided by product of the density of the film in grams/cubic centimeter times the area of the sample in square centimeters. The density of the film is the sum of the weight percentage of the polymer from which the film is made times the density of the polymer, plus the weight percentage of the filler times the density of the filler. “Without the filler” means measured in areas of the film where the filler is not affecting the gauge.

“Water vapor permeable film”, “water vapor permeable composite” and similar terms mean that the film, composite, etc., has a water vapor transmission rate (WVTR) of at least 100 grams per square meter per day (100 g/m²/day) measured using a LYSSY L80-4000K tester following the supplier's instructions and using the supplied GoreTex® membrane as the standard.

“Nonwoven material” means a web of individual fibers or filaments that is formed by means other than knitting or weaving. The fibers or filaments are interlaid, but not in an identifiable, repeating manner. The web contains bonds between some or all of the fibers or filaments. Such bonds may be formed, for example, by thermal, adhesive or mechanical means such as entanglement. The nonwoven web may be a spunbonded web, a meltblown web, a (bond) carded web, an air laid web, or any combination of these.

“Woven material” means a cloth or fabric which is made from fibers by a weaving or a knitting process.

All parts and percentages are by weight, unless indicated otherwise.

Unless otherwise indicated, any given range includes both endpoints used to state the range.

Water vapor permeable composites can be made from a water vapor permeable film comprising a film forming polymer and a relatively low amount of an inert porous filler material. The water vapor permeable film is a monolayer or a multilayer film comprising at least one layer which comprises at least one film forming polymer and an inert porous filler material. Such a layer is also known as a “WVTR layer”.

Advantageously, the WVTR of such a water vapor permeable film is at least 1000, preferably at least 2500 and more preferably at least 3000, g/m²/day or more. While a WVTR of more than 7500 g/m²/day is possible, the WVTR of the water vapor permeable film of this invention is typically in the range of from about 1000 to about 7500 g/n²/day. According to the present invention, water vapor permeability of the film is primarily attained through filler porosity. WVTR can be measured using known test methods and equipment, for example using the methods described in ASTM E 398-83 or ASTM E 96-00, or commercially available automatic equipment suitable for water vapor transmission rate testing, such as automatic water vapor permeability testers supplied by LYSSY AG, Zollikon, Switzerland, e.g. testers of LYSSY's L80 series, such as L80-4000 or L80-5000, or by MOCON in Minneapolis, Minn., e.g. a PERMATRAN 100K tester. The WVTR values and ranges set forth above are based on measurements performed using a LYSSY L80-4000K tester following the supplier's instructions and using the supplied GoreTex® membrane as the standard.

The water vapor permeable film is also a substantially liquid impermeable film, particularly with respect to water-based liquids such as water per se and body fluids. Methods to assess the liquid barrier properties of a material are known in the art and include hydrostatic pressure methods, such as international standard methods ISO 1420 AI or ISO 811. For example, the hydrohead test can be used as a measure of the liquid barrier properties of the films and composites of this invention. This test measures the height of water (in millibars) the film or composite will support before a predetermined amount of liquid passes through the film or composite. The larger the hydrohead value measured for a tested material, the better are its barrier properties against liquid penetration.

Preferably, water vapor permeable multilayer films comprise from two to seven layers, at least one of which comprises (i) a film forming polymer, and (ii) an inert porous filler material, and is capable of affording the desired water vapor permeability. Preferred multilayer films comprise one WVTR layer. The additional layers are selected so as to impart or enhance other desired film properties, for example, hot tack, heat-sealability, adhesion and/or structural properties. The additional layers are selected such that they have little, preferably no, adverse effect on the water vapor permeability of the film or the composite. For various reasons including ecological and economic reasons, the water vapor permeable films have as few layers as possible to meet the desired and/or required performance attributes.

Preferred water vapor permeable films for use in the present invention are monolayer, two-layer or three-layer films, one layer of which comprises a film-forming polymer and an inert, porous filler material. Monolayer films comprising a film-forming inert porous filler material are the most preferred water vapor permeable films.

The water vapor permeable film may be of any thickness appropriate for the intended use of the film or the composite. For economic and/or ecological reasons, film thickness is often and preferably minimized. The monolayer film should have a thickness which facilitates water vapor permeability, and which also permits structural integrity and liquid barrier performance. Monolayer films suitable for use in the present invention typically have a thickness in a range from 10 microns (0.4 mil) to 125 microns (5 mils), preferably from 20 microns (0.8 mil) to 75 microns (3 mils). Multilayer films typically have a total thickness in a range from 20 microns (0.8 mil) to 125 microns (5 mils).

The film-forming polymer may be of any suitable type and generally includes, without limitation, homopolymers, copolymers, interpolymers, such as, for example, block, graft, random and alternating copolymers, terpolymers, and the like. Suitable types of polymers include, for example, polyolefins, such as homopolymers, interpolymers and blends of ethylene and linear or branched α-mono-olefins having at least three carbon atoms, preferably three to ten carbon atoms. Examples of homopolymers which may be used in the present invention are polyethylene, polypropylene, poly(1-butene) and poly(3-methyl-1-pentene). Representative examples of suitable interpolymers are ethylene/ propylene, ethylene/butene, ethylene/pentene, ethylene/hexene, ethylene/heptene and ethylene/octene copolymers. Suitable categories of polyethylenes include, but are not limited to, high pressure low density polyethylene (LDPE), linear low density polyethylene (LLDPE), and high density polyethylene (HDPE). Examples of other homopolymers, copolymers and interpolymers which can be used are polyesters, including polyethylene terephtalate and polybutene terephtalate, nylon, polystyrene, including styrene block copolymers, such as styrene-butadiene-styrene (SBS) and hydrogenated SBS, vinyl polymers, such as polyvinyl chloride, polyvinyl acetate, ethylene vinyl-acetate copolymers and ethylene-vinyl alcohol copolymers, ethylene methylacrylic acid copolymers (ionomers), ethylene/styrene interpolymers, polyalkylene oxide polymers, and polycarbonate. Representative examples of blends are blends of homopolymers, such as polyethylene or polypropylene, and copolymers, such as ethylene/butene, ethylene/hexene or ethylene/octene, and blends of copolymers and/or interpolymers. Blends of two or more polymers preferably involve polymers which are at least partially compatible. The selection of the film-forming polymer or polymers should be consistent with the film requirements, for example with respect to processability and physical properties.

Preferred are film-forming polymers selected from the group consisting of ultra low density polyethylene (ULDPE), ethylene interpolymers made with single site catalyst technology, in particular homogeneously branched substantially linear ethylene/C₃-C₁₀ α-olefin interpolymers made with constrained geometry catalysts as available, for example, from; The Dow Chemical Company, random copolymers of polypropylene, propylene/ethylene copolymers, styrenic block copolymers, including for example, styrene-butadiene-styrene or styrene-isoprene-styrene block copolymers, and blends of these polymers.

The amount of film-forming polymer in the compositions employed to form the WVTR layer of the water vapor permeable films is 99.95 weight percent or less (based on the combined weight of the film forming polymer and filler). Preferably, the amount of film-forming polymer is 85, more preferably 90 and most preferably 95, weight percent or more of the film.

The filler material suitable for use in the present invention is inert to the film forming polymer or polymers. Suitable fillers include both organic and inorganic particulate materials that are incompatible, i.e., they do not dissolve or otherwise lose their particulate character when blended with the film-forming polymer, with the film-forming polymer or polymers. Inorganic particulate materials are the preferred fillers. The fillers may be natural or synthetic materials. Preferably, the particles are substantially spherical with a length to diameter ratio of approximately one to two.

The filler material in the water vapor permeable film or composite is porous. Such porous material is characterized in that a significant portion of the filler particles, advantageously at least about 80% or more, comprise pores, channels and/or voids traversing the particle from one surface to another surface or, if spherical in shape, its diameter. Porosity may be inherent to the selected filler material and/or may be generated or increased by suitable treatment, e.g. by mechanical and/or chemical treatment of the filler material.

According to a preferred embodiment of the present invention, porosity of the filler material is attained or enhanced by a suitable mechanical treatment, optionally in combination with a heat treatment. The mechanical treatment is such as to produce or significantly enhance the water vapor permeability of the film. Preferably, the mechanical treatment includes a suitable pressure treatment of the film comprising the film-forming polymer and the inert non-porous or inadequately porous filler material, optionally in combination with a heat treatment. For example, a suitable pressure treatment comprises contacting a film comprising at least one layer comprising at least one film-forming polymer and a filler material with a pressure plate or pressure rollers. The pressure should exceed the compressive strength of the filler particles and be sufficient to create or enhance particle porosity by crushing the particles. Advantageously, the pressure is in a range from 1 to 35, preferably from 3 to 30 and more preferably from 5 to 25, Newtons per millimeter (N/mm). A preferred filler material for the purpose of the present invention is a nonporous filler material, e.g., silica glass beads, which has been activated by crushing while dispersed within the film.

The mechanical treatment may be conducted at ambient temperature or at elevated temperature. For example, the pressure treatment may be carried out by passing the film between rollers, which optionally may be heated. Preferably, the roller temperature is between ambient temperature and the peak melting point of the polymer, more preferably between the softening point of the polymer melting at the highest temperature and its melting point, most preferably from 10 to 15 C below the melting point. If a multilayer film, then preferably the multilayer film is subjected to the mechanical treatment as opposed to just the component layers comprising at least one film-forming polymer and a filler material (and them combining the treated layers with the other layers of the multilayer film).

Chemical methods to create or enhance filler porosity are known in the art. Chemical treatment may include, for example, etching the filler material with a suitable acid or base, optionally in combination with thermal treatment. Silicas with controlled porosity can be made according to the process disclosed in U.S. Pat. No. 6,172,165, in particular Example 1. The chemical treatment should occur before the filler material is blended with the film-forming polymer used to make the WVTR layer.

Filler materials suitable for use in the present invention include, for example, silica, pumice, rhyolite, dacite, reticulite, scoria, lapilli, perlite, zeolites, polymeric carbohydrates, metal oxides such as aluminum oxide or magnesium oxide, metal sulfates such as barium sulfate, magnesium sulfate or aluminum sulfate, metal carbonates such as calcium carbonate, barium carbonate or magnesium carbonate, and clays. Such materials are commercially available from numerous suppliers. Preferred fillers are mineral, non-porous spherical materials, such as silicas (including glass beads). Mixtures of different filler materials can also be used.

In those embodiments of this invention in which filler porosity is created or enhanced by pressure treatment, e.g., through the use of calendering equipment, the particle size of the filler relative to the intrinsic thickness of the film should be such that the particles can be crushed. Advantageously, the average particle size of the filler is at least about two thirds of the intrinsic film thickness. Preferably, the ratio of average filler particle size to film gauge before pressure treatment is at least 0.67, more preferably at least 0.8, and most preferably at least 0.9 or more. The average filler particle size may also be greater than the intrinsic film thickness. Preferably, the ratio of average filler particle size to intrinsic film thickness before pressure treatment is below 2, and preferably below 1.8. Preferably, the filler particle size is greater than the intrinsic thickness of the film, i.e., the ratio of average filler particle size to intrinsic film thickness is greater than 1.

The filler particle size may affect the surface quality, e.g. the haptics of the film, and should be selected to meet the desired or required standard. Generally, smaller filler particles are found to give better surface haptics and higher hydrohead values (i.e., better impermeability to liquid water). Preferred are filler materials which have a narrow particle size distribution. A narrow particle size distribution is found to result in less variability in film performance, e.g., in WVTR across the film. Particularly preferred are such filler materials for which the average particle size, more preferably 90% or more of all particles, meet the general and preferred specifications relative to the film thickness previously described. The filler particle size can be determined by methods known in the art, for example by a Coulter counter method or by microscopy.

Two key factors affecting the WVTR of the water vapor permeable film are filler porosity and amount. The amount of filler in the WVTR layer is chosen such that it is sufficient to provide the desired water vapor permeability. Preferably, the amount of inert filler in the WVTR layer, based on the total amount of filler and film-forming polymer present in the layer, is at least 0.05, more preferably at least 0.1 and most preferably at least 0.5, weight percent or more. Preferably, the amount of filler in the WVTR layer is 15, more preferably 10 and most preferably about 5, weight percent or less.

The filler surface may be modified, for example such that it is more hydrophobic, using a surface-modifying agent. Surface modification may serve to improve the dispersion of the filler within the polymer matrix and/or adhesion to the polymer matrix. Suitable agents are known in the art and include, for example, various polymers and fatty acids, such as calcium stearate. Improved liquid barrier properties as reflected in, for example, higher hydrohead values, may be attained by increasing the adhesion between the filler material and the polymer matrix. For example, the interfacial adhesion can be increased by treating the surface of the glass beads with a silane polymer, such as an amino silane or a methacrylate silane, or by blending the polymer with a maleic anhydride grafted polymer. The methods of filler surface modification are well known in the art.

The compositions for the WVTR layer comprising the film forming polymer and the inert, porous filler material may further comprise additives to impart or enhance certain properties of the film, including, without limitation, pigments, antioxidants, stabilizers, antifogging agents, plasticizers, waxes, flow promoters, surfactants, materials added to enhance the processability of the composition, and tackifying resins or bonding agents, and in particular bonding agents permitting bonding of the water vapor permeable film to a nonwoven layer at a suitably low temperature, e.g. the bonding agents disclosed in U.S. Pat. No. 5,695,868, and the like. Any additives should be chosen, of course, such that the desired WVTR of the film remains at or above the targeted or desired value. The compositions can be prepared by conventional blending techniques using such equipment as, for example, two-roll mills, Banbury mixers, single-screw or twin-screw extruders.

The monoloyer or multilayer films used in the present invention can be formed using any suitable fabrication technique, and their properties can be designed to accommodate any desired end use of the composite. Suitable film-forming techniques include, for example, blown film extrusion, flat die extrusion, co-extrusion, extrusion coating and lamination techniques. The films can be wound up on a roll prior to being incorporated into the composite, and can be used on conventional equipment. Preferably, the films of the present invention are designed to be easily processed at cost-effective line speeds.

The water vapor permeable film of this invention may be imprinted and/or embossed, or otherwise surface-modified using methods known in the art, for example to improve the haptics of the film. The means used for the pressure treatment of the film can also be used to at least partially embossed or patterned the film provided, of course, that the pressure is 'sufficient to produce the targeted WVTR. If rollers are used for the pressure treatment, then both rollers may be patterned or embossed, or one roller may be patterned or embossed and the other one may be smooth. One or both of the rollers may be heated, or a secondary heat source may be used.

The water vapor permeable films provided by this invention allow for the reduction of scrap rates by eliminating or reducing the risk of defects related to calcium carbonate filler agglomeration. Furthermore, such films are advantageous in that a stretching step is not required to achieve the target WVTR.

In one embodiment, the present invention relates to a water vapor permeable, elastic film comprising at least one layer comprising at least one elastomeric film-forming polymer and an inert, porous filler material. Upon application of a biasing force, such an elastic film can be elongated to at least 150 percent of its original length, and it will recover at least 50 percent of its elongation upon release of the elongating, biasing force. For illustration, a film of a length of 1 meter, when elongated to at least 1.5 meter and subsequently released from the elongating force, will recover to a length of 1.25 meter or less. Preferred are elastic films which, upon release of the biasing force, will recover to substantially their original length. Suitable elastomeric film-forming polymers are known to those skilled in the art and include, for example, ethylene-based interpolymers made with single-site catalyst technology, e.g. using a metallocene or a constrained geometry catalyst, and block copolymers such polyurethanes, copolyether esters and styrene block copolymers. Preferred elastomeric polymers are ethylene/α-olefin, copolymers made using single-site catalyst technology and having a density of 0.895 g/cc or less.

In one embodiment, the present invention provides a water vapor permeable, substantially liquid water impermeable composite comprising a water vapor permeable film as previously described and one or more substrate or support layers, such as a woven material or a non-woven material. Advantageously, the composite according to the present invention has a WVTR of at least 1000, preferably at least 2000 and more preferably at least 2500, g/m²/day or more. Most preferably the composite according to the present invention has a WVTR in the range of from 2500 to 7500 g/m²/day. Preferred composites according to the invention have a hydrohead of at least 25, more preferably at least 40 and most preferably above 45, millibar.

In another embodiment, the composites comprise at least one non-woven fabric component, preferably a polyolefin-based fibrous non-woven web. Such a web may be made from polypropylene but other polyolefin fibers can also be used. Blends or mixtures of different polyolefin fibers and blends of polyolefin and nonpolyolefin fibers, such as polyester fibers, are also possible. Natural fibers may also be included in the fibrous non-woven web. Specific fiber types include single component fibers and multicomponent fibers such as side-by-side, sheath/core and island-in-the-sea bicomponent fibers. The fibers may be straight or crimped, solid or hollow. Fiber thickness is chosen to give the desired properties. Depending upon the intended end use, the non-woven substrates of the composites of the present invention may be selected such as to provide or improve one or more desired or required performance attributes of the composite. For example, the non-woven component may serve to improve aesthetics, particularly soft feel or appearance, wearer comfort, and ease of use. Alternatively or additionally, the non-woven may function as a cover stock, wicking layer, absorbent core, barrier layer or reinforcement layer. Furthermore, the non-woven may contribute to the cost-effectiveness of the composite. If appropriate, a hydrophobic nonwoven or a nonwoven containing super-absorbents may be used.

In certain other embodiments, the composites are laminates comprising the water vapor permeable film as previously described and a nonwoven material. The film preferably bonds to the nonwoven, and bonding is achieved without deleteriously affecting the integrity of the film in the bond areas using techniques known in the art.

Suitable methods for joining the films and the nonwoven are known in the art and include, for example, gluing by use of an adhesive or a bonding agent, e.g. a bonding agent included in the film composition or in the fibrous web, ultrasonic bonding, and thermal bonding. Thermal bonding can be accomplished through the use of heat and pressure. The chosen temperature should be below the melting temperatures of the film and the nonwoven, or below the temperature where the composite becomes stiff. Joining areas and bond patterns, such as point bonds, continuous lines and decorative patterns, may be varied depending on the particular end use.

For embodiments in which the film and the substrate material comprise different polymers such as polypropylene and nylon, the adhesion between the film and substrate may need to be enhanced. The inter surface adhesion may be enhanced by applying well-known adhesives or bonding agents to one or more of the surfaces. Also well-known in the art is exposure of one or more of the surfaces to corona discharge, plasma, flurie, ultraviolet, x-ray, gamma ray, beta ray or high energy electron treatment.

For laminates comprising a water vapor permeable film in which filler porosity is to be attained or enhanced by a pressure treatment, the present invention offers the advantage that the pressure treatment of the film and lamination can be effected in a single step.

The present invention also provides elastomeric composites comprising the elastic water vapor permeable film previously described and one or more substrate or support layers, e.g. a nonwoven fabric. Such composites are useful, for example; in articles where stretchability is desired or required, e.g. apparel which is conform to the contours of the wearer's body.

The water vapor permeable films and composites of the present invention are particularly suitable for use in disposable or durable articles requiring good water vapor permeability in combination with substantial impermeability to various liquids, in particular water-based liquids, such as water or body fluids. Such articles of manufacture are another aspect of the present invention and include, for example, absorbent hygiene products, medical or surgical disposables, industrial protective apparel, sport apparel (e.g., rain repellant but breathable jogging and exercise outfits), geotextiles and building materials, such as “house-wrap”, roofing components, and the like. Preferred are such fabricated articles made from or comprising a composite according to the present invention in which the substrate is a non-woven fabric. The composites of the present invention and its components, e.g., the water vapor permeable film and the nonwoven substrate, can be laminated or otherwise specifically designed to meet the needs of the article.

Absorbent hygiene products include, for example, disposable baby diapers, training pants which are highly absorbent, panty-like products designed to facilitate toddler toilet training, feminine hygiene products, e.g. sanitary napkins and panty liners, and adult incontinence products, such as underpads and adult diapers. The composite according to the present invention is suitable for use as a backsheet in an absorbent hygiene product, such as a diaper. In such a product, the nonwoven web preferably faces away from the absorbent core of such product.

Medical and surgical disposables serve, inter alia, to protect healthcare workers and patients and include, for example, single-use, sterile, surgical gowns and drapes, face masks, bandages and wound covers.

For use in building applications, such as “house-wrap”, fabrics are suitably laminated to the water vapor permeable film of this invention. Advantageously, the fabric has excellent strength properties and is capable of reinforcing the water vapor permeable film. The fabric is bondable to the film without significantly adversely affecting the water vapor permeability of the film. The fabric may be a woven or a nonwoven of any suitable material. For example, the fabric may be a woven based on a polyolefin, such as, for example, a low density polyethylene, a linear low density polyethylene,or a polypropylene, preferably a high density polyethylene or a polyethylene terephthalate, commonly referred to as a scrim.

### EXAMPLES

The density of a resin (in g/cc) is measured according to ASTM D-792. The melt index (in g/10 min) is measured at 190° C./2.16 kg according to ASTM D-1238.

The WVTR measures the breathability of a film or a composite, that is the steady water vapor flow in unit time through unit area of the film or composite, under specific conditions of temperature and humidity at each surface. The values reported below were determined using a commercially available water vapor transmission rate tester supplied by LYSSY AG in Zollikon, Switzerland (model L80-4000K).

The procedure for measuring WVTR requires that a specimen of approximately 10 cm by 10 cm is cut from the film sample and adhered to a specimen holder with an open area of 5 em². The sample is then placed in the testing chamber. The bottom half of the chamber contains water while the upper half is kept at a humidity of between about 10 to 15 percent to establish a humidity driving force of about 85 to 90 percent. All measurements are conducted at 38° C. and 90% relative humidity. The air is kept dry by circulation through a silica gel prior to and after entering the upper half of the chamber. The water vapor flow as a function of time (24 hours, i.e., one day) is detected by a resistance sensor in the upper chamber and compared to the standard measured under the same conditions:

$$WVTR ( sample ) = \frac{vaule ( s ample ) \times WVTR ( standard )}{value ( standard )}$$

GoreTex® permeable membrane with a thickness of 50 microns (2 mil) as supplied by LYSSY AG is used as a standard; under the set conditions of 38° C. and 90% relative humidity, the WVTR for said standard is determined to be 5000 g/m²/day.

The relative elasticity of the films is determined by measuring permanent set. The sample is extended at 254 mm/min (10 in/min) to strains of 50, 100, and 150 percent based on a gauge length of 10 cm (4 inches). The sample is held at this strain for 30 seconds before being released to 0 percent strain at a rate of 254 mm/min (10 in/min). The sample is extended again after 60 seconds at the same rate until a load greater than zero is achieved. The distance along the strain or x-axis on a plot of stress versus strain after the load increases above a value of zero is referred to as the “60 second set”.

The AFFINITY™ and ELITE™ resins used in the Examples are available from The Dow Chemical Company, Midland, Mich., U.S.A.

Nonporous glass beads having an average particle size of 65 microns (2.6 mil) and supplied by Potters Industries, a division of PQ Corporation, U.S.A., are used as the inert filler material in all the Examples.

### Example 1

Blown films are made from a composition comprising 50 percent by weight of a homogeneously branched substantially linear ethylene/octene copolymer having a density of 0.875 g/cc and a melt index of 3.0 g/10 min (AFFINITY™ KC 8852 resin), 45 percent by weight of a homogeneously branched substantially linear ethylene/octene copolymer having a density of 0.911 and a melt index of 6 g/10 min (AFFINITY™ PT 1409 resin), and 5 weight percent of the nonporous glass beads. The films are fabricated at a die temperature of 169° C. and have an intrinsic thickness of 38 μm (1.5 mil). The ratio of the average particle size to intrinsic film thickness is 1.5. The films are subjected to mechanical treatment at elevated temperatures by passing them between two smooth rollers having a polished and hardened surface. Both rollers have a width of 30.5 cm (12 inches) and a diameter of 12.7 cm (5 inches). The treatment conditions and results are shown in Table 1. The given temperatures are measured in the center portion of the roller surface using a thermocouple with a rolling contact; the pressure is the applied pressure measured by converting the air cylinder pressure to a weight and then normalizing based on the roll width. The stated film gauge is measured after the treatment.

TABLE 1

| | Temperature, | Pressure, | Gauge, | WVTR |
|---|---|---|---|---|
| Sample | C. | N/mm (lb/in) | μm (mil) | (g/m²/day) |
| 1 | 40 | 5.6 (32) | 35 (1.4) | 1131 |
| 2 | 40 | 22 (126) | 35 (1.4) | 3054 |
| 3 | 60 | 5.6 (32) | 34 (1.3) | 2312 |
| 4 | 60 | 22 (126) | 24 (1) | 3422 |
| 5 | 70 | 22 (126) | 33 (1.3) | 2661 |

### Example 2

A blown film made from 20% of AFFINITY™ KC8852 resin (0.875 g/cc, 3.0 g/10 min), 72.5% of AFFINITY™ PT1409 resin (0.911 g/cc; 6 g/10 min) and 7.5% of the nonporous glass beads is fabricated at a temperature of 204° C. The intrinsic film thickness is 1.5 mil. The film is subjected to mechanical treatment under the conditions described in Example 1. The treatment conditions and WVTR results are shown in Table 2.

TABLE 2

| | Temperature, | Film Gauge, | WVTR |
|---|---|---|---|
| Sample | C. | (μm (mil)) | (g/m²/day) |
| 6 | 40 | 41 (1.6) | 2060 |
| 7 | 60 | 33 (1.3) | 2846 |
| 8 | 70 | 38 (1.5) | 2620 |
| 9 | 80 | 23 (0.9) | 2714 |

### Example 3

A blown film is made from 90% of AFFINITY™ PT 1409 resin (0.911 g/cc, 6 g/10 min) and 10 weight percent of nonporous glass beads at a temperature of 204° C. using the fabrication and mechanical treatment equipment described in Example 1. The intrinsic film thickness is 1.5 mil; the applied pressure is 22 N/mm. The treatment temperatures and results are shown in Table 3.

TABLE 3

| | Temperature, | Film Gauge, | WVTR |
|---|---|---|---|
| Sample | C. | (μm (mil)) | (g/m²/day) |
| 10 | 40 | 36/1.4 | 2594 |
| 11 | 60 | 36/1.4 | 2835 |
| 12 | 80 | 29/1.2 | 3305 |

### Example 4

A water vapor permeable blown film is made from a composition comprising 50% of ELITE™ 5400 resin (0.917 g/cc, 1 g/10 min), 45 weight percent of AFFINITY™ PT 1409 resin and 5 weight percent of the nonporous glass beads at a temperature of 230° C. as described in Example 1. The pressure is 22 N/mm. The temperatures of the mechanical treatment and the results are shown in Table 4.

TABLE 4

| | Temperature, | Film Gauge, | WVTR |
|---|---|---|---|
| Sample | C. | (μm (mil)) | (g/m²/day) |
| 13 | 40 | 36/1.4 | 1936 |
| 14 | 80 | 25/1 | 2639 |
| 15 | 100 | 20/0.8 | 2340 |

### Example 5

A blown film (gauge of 38 μm or 1.5 mil) is made from a composition comprising 75% of an ethylene vinyl-acetate copolymer containing 12% vinyl acetate with a melt index of 2.5 g/10 min (ELVAX™ 3130 resin available from DuPont E.I. de Nemours), 22.5% of AFFINITY™ PT1409 resin and 2.5% of the nonporous glass beads. The film is subjected to pressure treatment at a pressure of 22 N/mm and a temperature of 60° C. The WVTR of the resulting 26 micron (1.1 mil) film is 1660 g/m²/day.

### Example 6

A blown film (gauge of 38 μm or 1.5 mil) is made from a composition comprising 50% of an ethylene vinyl-acetate ELVAX™ 3130 copolymer (12% vinyl acetate), 45% of AFFINITY™ PT1409 resin and 5% of the nonporous glass beads. The film is subjected to a pressure of 22 N/mm at a temperature of 60° C. The WVTR of the resulting 35 micron (1.4 mil) film is 2365 g/m²/day.

### Example 7

The film of Sample 15 is laminated to a spunbond nonwoven of polypropylene with a basis weight of 20 g/m². The lamination temperature and pressure are 93° C. and 6.9 kPa, respectively. The WVTR of the resulting laminate having a basis weight of 40 g/m² is 3160 g/m²/day.

### Example 8

The relaxation data (set measured after 60 seconds of recovery time following the applied strain) for two of the above-described elastic water vapor permeable film samples are shown in Table 5.

TABLE 5

| Sample | Extension (%) | 60 Second Set (%) |
|---|---|---|
| 15 | 50 | 10 |
| 15 | 100 | 38 |
| 15 | 150 | 73 |
| 5 | 50 | 5 |
| 5 | 100 | 11 |
| 5 | 150 | 56 |

While this invention has been described in certain detail in the preceding examples, this detail is for the purpose of illustration and is not to be construed as a limitation upon the invention as described in the following claims. All U.S. patents and allowed applications cited above are incorporated herein by reference.

1. A layered, water vapor permeable composite comprising at least one water vapor permeable film layer and at least one substrate layer, the water vapor permeable film (i) comprising at least one film forming polymer and at least one inert porous filler, the filler present in an amount of between about 0.05 and about 7.5 percent by weight based on the weight of the film (ii) having a water vapor transmission rate of at least 100 g/m²/day, and (iii) activated:

2. The composite of claim 1 in which the water vapor permeable film layer comprises from about 0.1% to about 7.5 weight percent of the filler.

3. The composite of claim 2 in which the water vapor permeable film is activated by mechanical treatment.

4. The composite of claim 3 in which at least one substrate layer is of a non-woven construction.

5. The composite of claim 4 in which the film-forming polymer is an ethylene interpolymer or a blend comprising one or more ethylene interpolymers.

6. The composite of claim 5 in which the water vapor permeable film is elastic.

7. The composite of claim 6 in which the water vapor transmission rate is in the range of 1000 to 7500 g/m²/day.

8. The composite of claim 1 in which at least one substrate is of a woven construction.

9. (canceled)

10. The composite of claim 1 in which at least one of the permeable film layer or the substrate layer (i) comprises one or more of an adhesive or a bonding agent, or (ii) has been exposed to one or more of corona discharge, plasma, flame ultraviolet light x-rays gamma rays, beta rays or high energy electrons.

11. (canceled)

12. An article of manufacture comprising the layered composite of claim 1.

13. The article of manufacture of claim 12 selected from the group consisting of an absorbent hygiene product, a medical disposable product, a surgical disposable product, protective apparel product, a geotextile product and a building material product.

14. A house wrap comprising the composite of claim 1.

15. A backsheet of an absorbent hygiene product, the backsheet (i comprising the composite of claim 1, and (ii) the composite of claim 1 having a water vapor transmission rate of at least 1000 g/m²/day.

16. (canceled)

17. (canceled)

18. A method for making a water vapor permeable composite having a water-vapor transmission rate of at least 100 g/m²/day, the method comprising the steps of (i) subjecting to a pressure treatment a film comprising at least one film-forming polymer and between about 0.05 and about 7.5 percent by weight, based on the weight of the film, of an inert filler material, and (ii) joining the film to a substrate layer, the two steps performed simultaneously.

19. (canceled)

20. (canceled)

21. The composite of claim 1 in which the film has an intrinsic thickness and the filler an average particle size, and the ratio of average filler particle size to the intrinsic thickness of the film is between about 0.67 and about 1.8.

22. The method of claim 15 in which the pressure treatment is performed at a temperature between about 10 and about 15 degrees C. below the melting point of the highest melting point polymer from which the film is made.
